(19) United States
(12) Patent Application Publication
(10) Pub. No.: US 2024/0168813 A1
(43) Pub. Date: May 23, 2024

(54) WORKFLOW VISUALIZATION TECHNIQUES

(71) Applicant: PREFECT TECHNOLOGIES, INC., Washington, DC (US)

(72) Inventors: Christopher D. White, Half Moon Bay, CA (US); Zachariah Nicholas Brown, Washington, DC (US); Jeremiah Leeam Lowin, Washington, DC (US)

(21) Appl. No.: 18/514,567

(22) Filed: Nov. 20, 2023

Related U.S. Application Data
(60) Provisional application No. 63/426,747, filed on Nov. 19, 2022.

(51) Int. Cl. G06F 9/50

(52) U.S. Cl. CPC G06F 9/5038; G06F 9/5072

(57) ABSTRACT

Techniques are provided for visualizing a run of a workflow on a GUI. The techniques include: (a) rendering an origin node of the workflow at a central position and an innermost ring therearound; (b) adding to the first ring, independent nodes representing respective tasks invoked by the workflow that are not dependent on any other task in order of invocation in a distributed manner, together with edges drawn from the origin node to respective added independent nodes; (c) rendering one or more outer rings around the innermost ring; and (d) adding to each of the outer rings, dependent nodes representing respective tasks invoked by the workflow that are dependent on another task represented by another node on another ring closer to the origin node in order of invocation in a distributed manner together with edges drawn to each added dependent node from all nodes representing tasks upon which the respective task represented by that dependent node is dependent.

### CROSS REFERENCE TO RELATED APPLICATION

This patent application claims priority to U.S. Provisional Patent Application No. 63/426,747 filed on Nov. 19, 2022, entitled, “WORKFLOW VISUALIZATION TECHNIQUES,” the contents and teachings of which are hereby incorporated herein by reference in their entirety.

### BACKGROUND

Certain tasks may be repeated with some degree of frequency on computing systems. Some computing systems employ workflows to group tasks together and to automate scheduling of such tasks and workflows.

In some computing systems, states may be used to keep track of the execution of a task or workflow. Certain state transitions may be permitted while others are not.

### SUMMARY

Although execution of tasks and workflows using states is generally quite effective, one drawback to some such systems is that it may be difficult to visualize how a particular run of a task or workflow is executing or has already executed. Some conventional systems require that all possible execution paths be registered in advance, allowing a graph to be generated easily. However, in systems that do not require such registration, it can be difficult to construct a graph, let alone a graph that is clear to users.

Thus, it would be desirable to visualize a workflow in a clear and concise manner without advance knowledge of all possible execution paths, or while the workflow is executed in real-time. This may be accomplished by placing nodes on concentric rings of a visualization, the nodes representing tasks of a workflow, in order of invocation, with ring assignments being based on task dependencies. Once a node has been placed on a ring, its position does not change upon additional nodes being rendered (e.g., due to new tasks being invoked). Directed edges may be drawn to indicate dependencies from nodes on more inward rings to nodes on more outward rings. Such techniques also have a benefit of allowing workflows to be visualized in real-time, during execution.

In one embodiment, a method, performed by a computing device, of visualizing a run of a workflow on a graphical user interface (GUI) on a display device is provided. The method may include: (a) rendering an origin node of the workflow at a central position of the GUI and an innermost ring around the central position; (b) adding to the first ring of the GUI, independent nodes representing respective tasks invoked by the workflow that are not dependent on any other task, the independent nodes being added in order of invocation in a distributed manner, together with edges drawn from the origin node to respective added independent nodes of the first ring; (c) rendering one or more outer rings around the innermost ring of the GUI; and (d) adding to each of the one or more outer rings of the GUI, dependent nodes representing respective tasks invoked by the workflow that are dependent on another task represented by another node on another ring closer to the origin node, the dependent nodes being added in the order of invocation in a distributed manner, together with edges drawn to each added dependent node of the one or more outer rings from all nodes representing tasks upon which the respective task represented by that dependent node is dependent. A corresponding computer program product, apparatus, and system for performing the provided method and similar methods are also provided.

### BRIEF DESCRIPTION OF THE DRAWINGS

The foregoing and other objects, features, and advantages will be apparent from the following description of particular embodiments, as illustrated in the accompanying drawings in which like reference characters refer to the same parts throughout the different views. The drawings are not necessarily to scale, emphasis instead being placed upon illustrating the principles of various embodiments.

FIG. 1 illustrates an example system, apparatus, and computer program product for use in connection with one or more embodiments.

FIG. 2 illustrates an example method in accordance with one or more embodiments.

FIG. 3 illustrates an example method in accordance with one or more embodiments.

FIG. 4 illustrates an example visualization in accordance with one or more embodiments.

FIG. 5 illustrates an example visualization in accordance with one or more embodiments.

FIGS. 6A-6B illustrate example visualizations in accordance with one or more embodiments.

FIG. 7 illustrates an example visualization in accordance with one or more embodiments.

FIGS. 8A-8B illustrate example methods in accordance with one or more embodiments.

### DETAILED DESCRIPTION

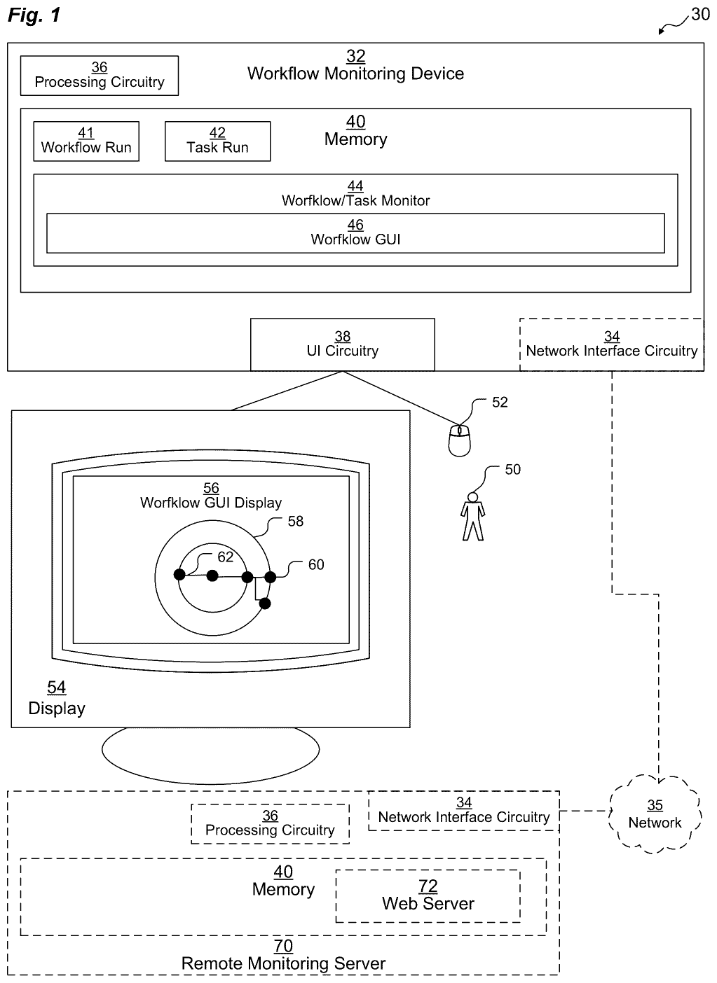

FIG. 1 depicts an example system 30 for use in connection with various embodiments. System 30 includes a workflow monitoring device 32. In some embodiments, system 30 may also include a remote monitoring server 70 and a network 35.

Network 35 may be any kind of communications network or set of communications networks, such as, for example, a LAN, WAN, SAN, the Internet, a wireless communication network, a virtual network, a fabric of interconnected switches, etc.

Both workflow monitoring device 32 and remote monitoring server 70 may be any kind of computing device, such as, for example, a personal computer, laptop, workstation, server, enterprise server, tablet, smartphone, etc. Both workflow monitoring device 32 and remote monitoring server 70 may include processing circuitry 36, network interface circuitry 34, and memory 40. In addition, workflow monitoring device 32 also includes user interface (UI) circuitry 38 for connecting to a UI input device 52 and a display device 54. Both workflow monitoring device 32 and remote monitoring server 70 may also include various additional features as is well-known in the art, such as, for example, user interface circuitry, interconnection buses, etc.

Processing circuitry 36 may include any kind of processor or set of processors configured to perform operations, such as, for example, a microprocessor, a multi-core microprocessor, a digital signal processor, a system on a chip (SoC), a collection of electronic circuits, a similar kind of controller, or any combination of the above.

Network interface circuitry 34 may include one or more Ethernet cards, cellular modems, Fibre Channel (FC) adapters, InfiniBand adapters, wireless networking adapters (e.g., Wi-Fi), and/or other devices for connecting to a network 35.

UI circuitry 38 may include any circuitry needed to communicate with and connect to one or more user input devices 52 and display screens 54 operated by a user 50. UI circuitry 38 may include, for example, a keyboard controller, a mouse controller, a touch controller, a serial bus port and controller, a universal serial bus (USB) port and controller, a wireless controller and antenna (e.g., Bluetooth), a graphics adapter and port, etc.

Display screen 54 may be any kind of display, including, for example, a CRT screen, LCD screen, LED screen, etc. Input device 52 may include a keyboard, keypad, mouse, trackpad, trackball, pointing stick, joystick, touchscreen (e.g., embedded within display screen 54), microphone/voice controller, etc. In some embodiments, instead of being external to workflow monitoring device 32, the input device 52 and/or display screen 54 may be embedded within the workflow monitoring device 32 (e.g., a cell phone or tablet with an embedded touchscreen).

Memory 40 may include any kind of digital system memory, such as, for example, random access memory (RAM). Memory 40 stores an operating system (OS, not depicted, e.g., a Linux, UNIX, Windows, MacOS, or similar operating system) and various drivers and other applications and software modules configured to execute on processing circuitry 36 as well as various data.

Memory 40 of workflow monitoring device 32 stores a workflow/task monitor 44, which is configured to monitor and visually depict a status of one or more workflow runs 41 and/or task runs 42. Workflow runs 41 and task runs 42 may execute on workflow monitoring device 32 or on one or more other computing devices (e.g., remote monitoring server 70 or one or more other computing devices, not depicted).

A workflow may include a sequence of tasks. A workflow may be embodied as a container for workflow logic and allow users 50 to interact with and reason about the state of their workflow runs 41, which are instances of a workflow being run or executed.

Workflows are similar to functions. They can take inputs, perform work, and return an output. When a function becomes a workflow, its behavior changes, giving it the following advantages:
State transitions are reported to an API, allowing observation of workflow execution.
Input argument types can be validated.
Retries can be performed on failure.
Timeouts can be enforced to prevent unintentional, long-running workflows.

Workflows can include calls to tasks as well as to other workflows (which may then be called “subflows”). A task is a function that represents a discrete unit of work in a workflow. A workflow need not contain any tasks—it is possible for a workflow to contain logic without calling any tasks or subflows. Tasks are special because they may receive metadata about upstream dependencies and the state of those dependencies before they run, even if the tasks do not receive any explicit data inputs. This allows a task to wait on the completion of another task before executing. Tasks also take advantage of automatic logging to capture details about task runs 42 such as runtime, tags, and final state. Tasks can automatically retry on failure. A new task run 42 is not created when a task is retried.

In some embodiments, all tasks must be called from within a workflow; tasks may not be called from other tasks.

States are rich objects that contain information about the status of a particular workflow run 41 or task run 42. More detail about states will be provided below.

A subflow is created when a workflow function is called inside the execution of another workflow. The primary workflow is the “parent” flow. The workflow created within the parent is the “child” flow or “subflow.” Subflow runs behave like normal workflow runs 41. There is a full representation of the workflow run 41 in the backend as if the workflow had been called separately. When a subflow starts, the subflow will create a new task runner for tasks within the subflow. When the subflow completes, the task runner is shut down. Subflows typically block execution of the parent workflow run 41 until completion. However, asynchronous subflows can be run in parallel. Subflows differ from normal workflows in that they will resolve any passed task futures into data. This allows data to be passed from the parent workflow to the child easily. The relationship between a child and parent workflow may be tracked by creating a special task run 42 in the parent workflow. This task run 42 will mirror the state of the child flow run 41.

A workflow or a task may be configured to operate in various operational states. While a workflow run 41 or task run 42 operates in a particular operational state, processing circuitry 36 may be configured to execute operations associated with the respective workflow or task in that state (e.g., by executing code for that workflow or task in that state).

The final state of a workflow run 41 or a task run 42 is determined by its return value. In an embodiment, the following rules may be used to ascertain the final state of a workflow:
If an exception is raised directly in the workflow function, the workflow run 41 is marked as failed.
If the workflow 46 does not return a value (or returns None), its final state is determined by the final states of all of the tasks and subflows within it. In particular, if any task run 42 or subflow run failed, then the final state of the workflow run 41 is marked as failed.
If the workflow run 41 returns any other object, then it is marked as completed.

Results of tasks (“task results”) may be cached in memory 40 during execution of a workflow run 41. Caching refers to the ability of a task run 42 to reflect a finished state without actually running the code that defines the task by retrieving a cached state. This allows for efficient reuse of results of tasks that may be expensive or time consuming to run with every workflow run 41 by reusing cached task results if the inputs to a task have not changed. Thus, task results are available within the context of a workflow run 41 and task retries may use these task results. A new state is added to a state history of the original task run.

To determine whether a task run 42 should retrieve a cached state, “cache keys” may be used. A cache key is a string value that indicates if one run should be considered identical to another. When a task run 42 with a cache key finishes, that cache key is attached to its state. When each task run 42 starts, workflow/task monitor 44 checks for finished states with a matching cache key. If a finished state with an identical key is found, workflow/task monitor 44 will use the cached state instead of running the task again.

In some embodiments, there may be a need to actively prevent too many tasks runs 42 from executing simultaneously. For example, if many tasks across multiple workflows are designed to interact with a database that only allows 10 connections, it is desirable to make sure that no more than 10 tasks runs 42 that connect to this database are running at any given time. Task concurrency limits may be utilized to achieve this. Task concurrency limits use task tags, which are string labels that may optionally be included as arguments when calling a task. An optional concurrency limit may be passed as the maximum number of concurrent task runs 42 in a state for tasks with a given tag. The specified concurrency limit applies to any task to which the tag is applied. If a task has multiple tags, it will run only if all tags have available concurrency. Tags without explicit limits are considered to have unlimited concurrency. Task tag limits are checked whenever a task run 42 attempts to enter a state of “Running.” If there are no concurrency slots available for any one of the tags of a task, the transition to the state of Running will be delayed and the client is instructed to try entering that state again after a waiting period (e.g., 30 seconds).

As mentioned above, states are rich objects that contain information about the status of a particular workflow run 41 or task run 42. At any moment, the current state or the history of states of a run 41, 42 may provide information about that run 41, 42, such as, for example:
that a task is scheduled to make a third run attempt in 1 hour
that a task succeeded and what data it produced
that a task was scheduled to run but was later cancelled
that a task used the cached result of a previous run instead of re-running
that a task failed because it timed out

It should be understood that reference to the state of a workflow or a task may refer to the state of a workflow run 41 or of a task run 42. Workflows and tasks are templates that describe what a system does; only when the system runs does it also take on a state. So while a task might be referred to as “running” or being “successful,” it may refer to a specific instance of the task (i.e., a task run 42) is in that state.

States have names and types. State types are canonical, with specific orchestration rules that apply to transitions into and out of each state type. A state's name, is often, but not always, synonymous with its type. For example, a task run 42 that is running for the first time has a state with the name Running and the type Running. However, if the task retries, that same task run 42 will have the name Retrying and the type Running as its state. Each time the task run 42 transitions into the Running state, the same orchestration rules are applied.

There are terminal state types from which there are no orchestrated transitions to any other state type:
COMPLETED
CANCELLED
FAILED
CRASHED

An example of states and state types is presented in Table 1.

TABLE 1

| State Name | State Type | Terminal? | Description |
|---|---|---|---|
| Scheduled | SCHEDULED | No | The run will begin at a particular time in the |
| | | | future. |
| Late | SCHEDULED | No | The run's scheduled start time has passed, but it |
| | | | has not transitioned to PENDING (e.g., five |
| | | | seconds by default). |
| Awaiting | SCHEDULED | No | The run did not complete successfully because |
| Retry | | | of a code issue and had remaining retry |
| | | | attempts. |
| Pending | PENDING | No | The run has been submitted to run but is |
| | | | waiting on necessary preconditions to be |
| | | | satisfied. |
| Running | RUNNING | No | The run code is currently executing. |
| Retrying | RUNNING | No | The run code is currently executing after |
| | | | previously not completing successfully. |
| Cancelled | CANCELLED | Yes | The run did not complete because a user |
| | | | determined that it should not. |
| Completed | COMPLETED | Yes | The run completed successfully. |
| Retrieved | COMPLETED | Yes | A previous run having the same inputs |
| Cache | | | completed successfully (if caching is used), and |
| | | | its cached results are used as outputs. |
| Failed | FAILED | Yes | The run did not complete because of a code |
| | | | issue and had no remaining retry attempts. |
| Crashed | CRASHED | Yes | The run did not complete because of an |
| | | | infrastructure issue. |

A workflow run 41 is an instance of execution of a particular workflow that is either currently running or that has already completed. A task run 42 is an instance of execution of a particular task that is either currently running or that has already completed.

Workflow/task monitor 44 includes a workflow graphical user interface (GUI) 46 that is configured to display a workflow GUI display 56 on display device 54. In some embodiments, workflow/task monitor 44 and/or workflow GUI 46 may operate within a web browser (not depicted) and be controlled remotely by a web server 72 running on remote monitoring server 70.

Workflow GUI display 56 may display a plurality of concentric rings 58, cach containing one or more nodes 60. Nodes 60 represent respective tasks or subflows (or, in the case of the central node, an entire workflow). Edges 62 connect some of the nodes 60, indicating a dependence relationship.

Memory 40 may also store various other data structures used by the OS and workflow/task monitor 44 and/or various other applications and drivers. In some embodiments, memory 40 may also include a persistent storage portion. Persistent storage portion of memory 40 may be made up of one or more persistent storage devices, such as, for example, magnetic disks, flash drives, solid-state storage drives, or other types of storage drives. Persistent storage portion of memory 40 is configured to store programs and data even while the computing device 32, 70 is powered off. The OS, workflow/task monitor 44, and/or various other applications and drivers are typically stored in this persistent storage portion of memory 40 so that they may be loaded into a system portion of memory 40 upon a system restart or as needed. The OS, workflow/task monitor 44, and/or various other applications and drivers, when stored in non-transitory form either in the volatile or persistent portion of memory 40, each form a computer program product. The processing circuitry 36 running one or more applications thus forms a specialized circuit constructed and arranged to carry out the various processes described herein.

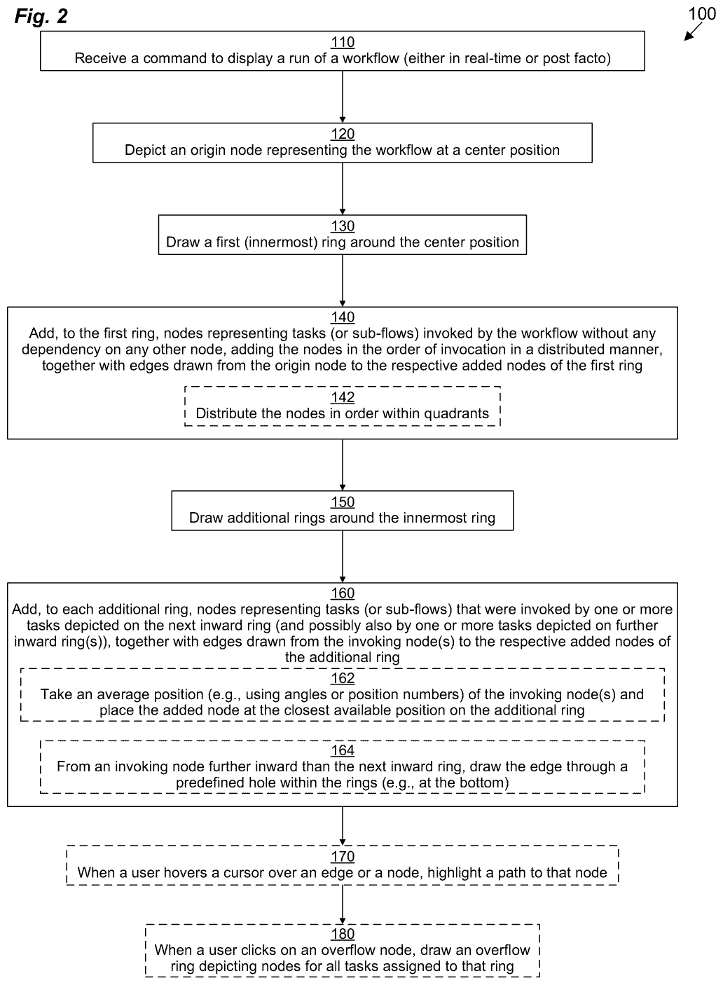

FIG. 2 illustrates an example method 100 performed by a workflow monitoring device 32 for visualizing a workflow run 41. It should be understood that any time a piece of software (e.g., OS, workflow/task monitor 44, workflow GUI 46, etc.) is described as performing a method, process, step, or function, what is meant is that a computing device (e.g., workflow monitoring device 32 or remote monitoring server 70) on which that piece of software is running performs the method, process, step, or function when executing that piece of software on its processing circuitry 36. It should be understood that one or more of the steps or sub-steps of method 100 may be omitted in some embodiments. Similarly, in some embodiments, one or more steps or sub-steps may be combined together or performed in a different order.

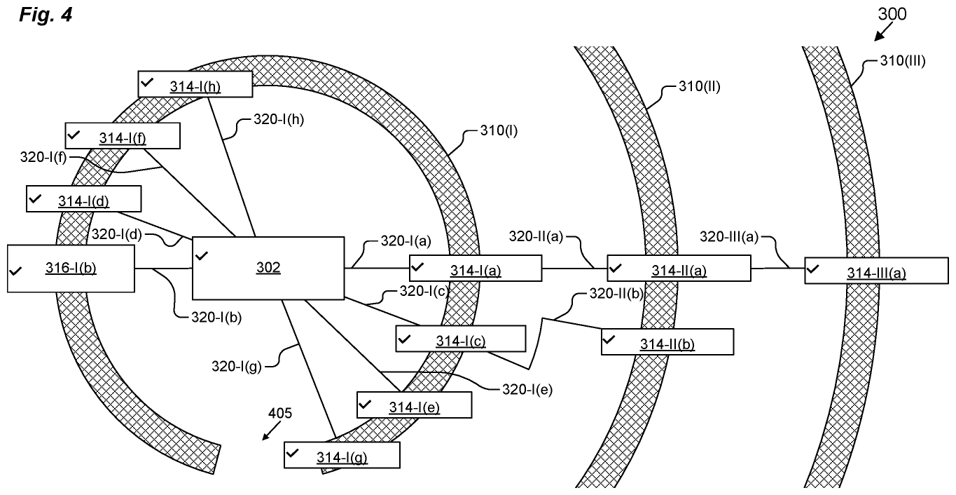

In step 110, workflow/task monitor 44 receives a command directing it to display details about a workflow run 41. Then, in step 120, workflow GUI 46 depicts an origin node representing the workflow run 41 at a center position of workflow GUI display 56. With reference to FIG. 4, for example, visualization 300, representing an example of workflow GUI display 56, includes an origin node 302.

In step 130, workflow GUI 46 draws a ring 58 at an innermost position around the center position as first ring 310(I).

In step 140, workflow GUI 46 adds, to the first ring 310(I), nodes 60 that represent task runs 41 (or subflow runs 42) invoked by the workflow run 41 defined by the origin node 302. Nodes 60 of the first ring 310(I) are not dependent on any other nodes 60 (i.e., the underlying tasks are not dependent on completion of any other tasks), and they are added in the order in which they were invoked. These nodes 60 are added in a distributed manner around the first ring 310(I) in the order in which their underlying tasks were invoked. Step 140 also includes drawing edges 62 from the origin node 302 to the respective nodes 60 added to first ring 310(I). With reference to the example of FIG. 4, inner nodes 314-I, 316-I are distributed around the first ring 310(I). As depicted, there are two different types of tasks that can underlie nodes 60. If a task is a straightforward task, then a simple node 314 is used, representing a task run 42. If a task is itself a workflow including sub-tasks, then a subflow node 316 is used, representing another workflow run 41. A user 50 may click on a subflow node 316 to bring up a separate visualization representing the subflow instead of the original workflow run 41 represented by the origin node 302.

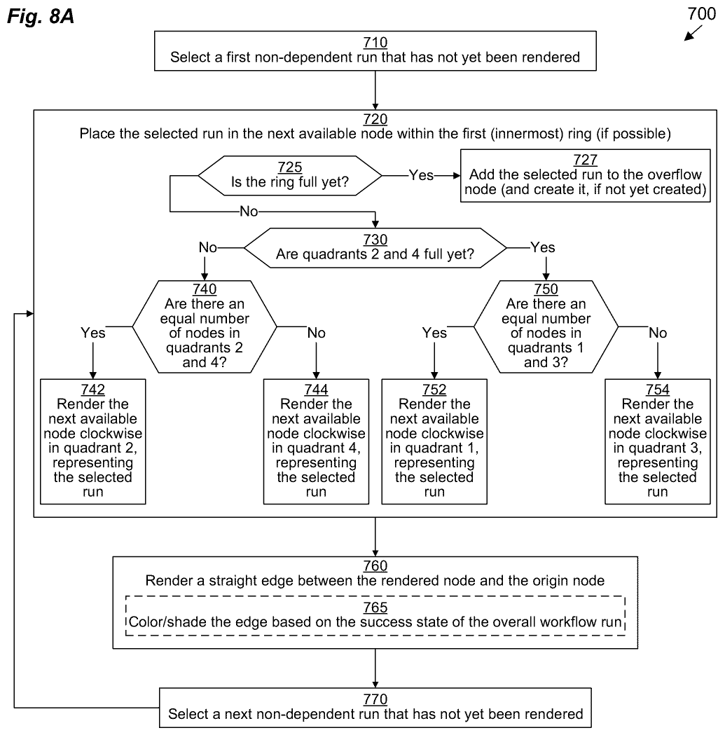

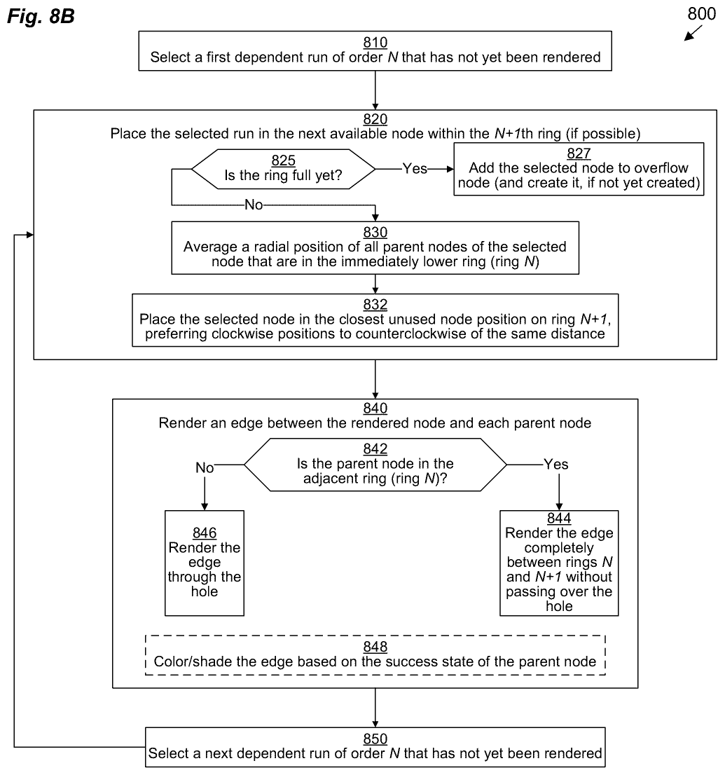

In some embodiments, step 140 may include sub-step 142. In sub-step 142, workflow GUI 46 distributes the nodes 314, 316 around the innermost ring 310(I) within quadrants. For example, in one embodiment, the lower-right quadrant (corresponding to 3:00 to 6:00 on a clockface) and the upper-left quadrant (corresponding to 9:00 to 12:00) are alternately filled in a clockwise direction. Once those quadrants have been filled, the upper-right quadrant (corresponding to 12:00 to 3:00) and the lower-left quadrant (corresponding to 9:00 to 12:00) are alternately filled in a clockwise direction. For example, as depicted in FIG. 4, node 314-I(a) is placed first, followed by node 316-I(b), followed by node 314-I(c), followed by node 314-I(d), followed by node 314-I(e), followed by node 314-I(f), followed by node 314-I(g), followed by node 314-I(h). Another example of such an approach is provided according to various embodiments in FIGS. 8A and 8B, described below.

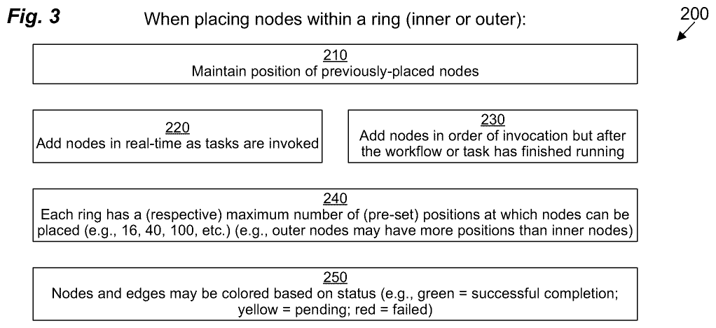

FIG. 3 depicts an example method 200. Method 200 includes various steps that may be performed while placing nodes 60 within any ring 58, whether it is the innermost ring 310(I) or any of the other rings 310(II), 310(III), etc. In step 210, when a new node 60 is being placed on a ring 58, the positions of previously-placed nodes 60 is maintained.

Steps 220 and 230 represent two different use cases. In step 220, nodes 60 are added in real-time during operation of the workflow run 41, and the nodes 60 are added in order as they are invoked. In step 230, all nodes 60 are added after operation of the workflow run 41 has completed, and these nodes 60 are added in the same order as they were invoked during operation.

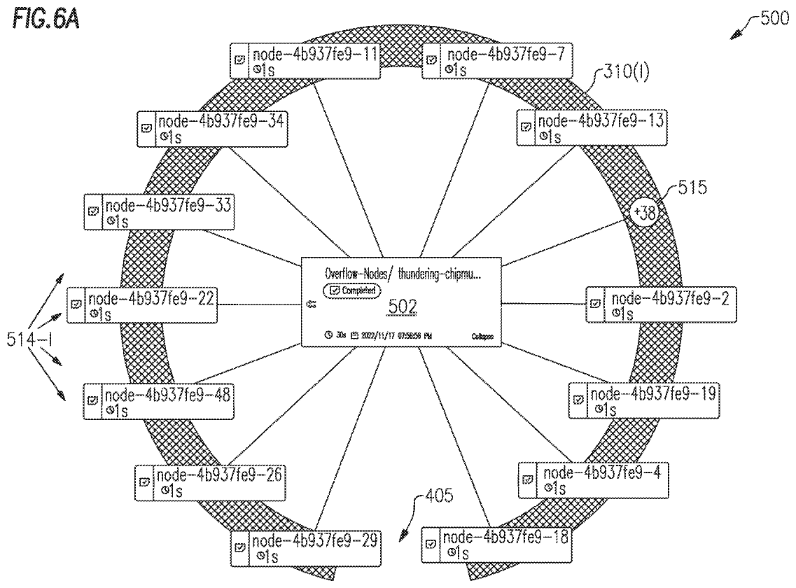

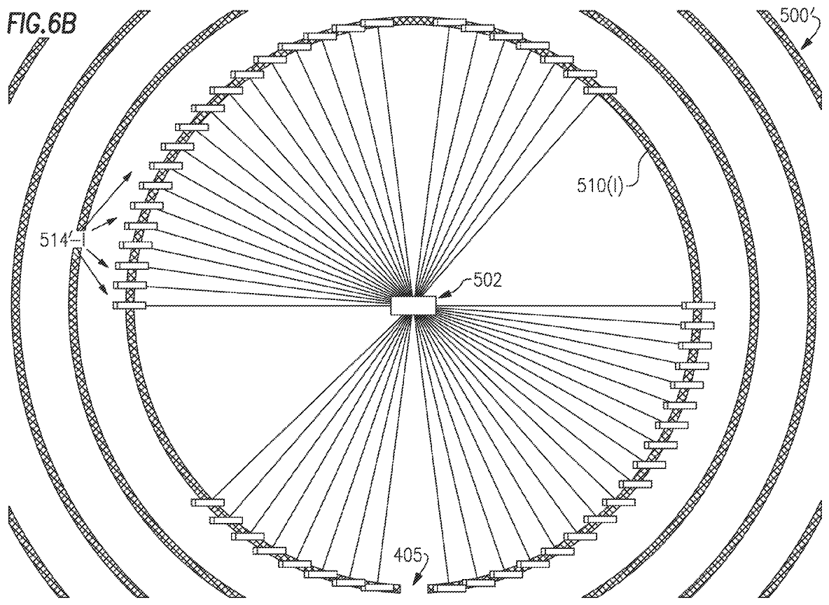

In step 240, nodes 60 are added to a ring 58 up until a maximum number of nodes 60 for that ring 58 has been reached. For example, the maximum number might be 16, 40, or 100. In some embodiments, first ring 310(I) has a first maximum number, and each successive ring 310(II), 310(III), etc. has its own respective maximum larger than the previous ring 58. For example, ring 310(I) might have a maximum of 16, ring 310(II) might have a maximum of 24, and ring 310(III) might have a maximum of 40. In some embodiments, there may be a pre-set position within each ring 58 for every node 60 assigned to that ring 58. If the maximum number of nodes 60 is reached, if any new nodes 60 are assigned to that ring, then an overflow node 515 is created (see visualization 500 of FIG. 6A, representing an example of workflow GUI display 56), which is used to represent all subsequently-added nodes on that ring.

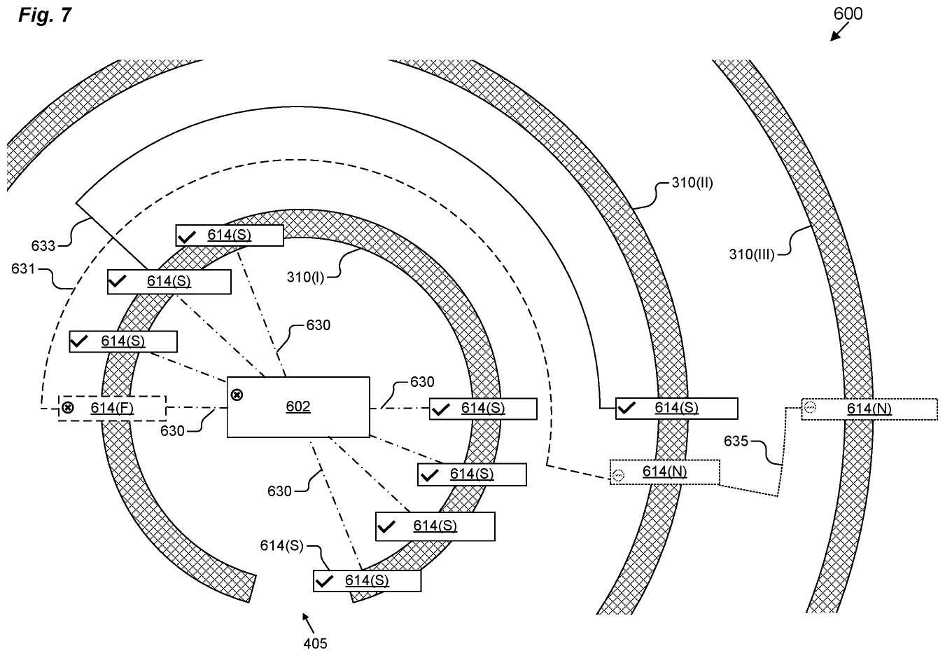

In step 250, nodes 60 and edges 62 may be colored based on a completion status or state of its respective task run 42 (or subflow run 41). For example, blue may indicate successful completion of a task run 42 (or subflow run 41) while a workflow run 41 is still executing, green may indicate successful completion of a task run 42 (or subflow run 41) after the workflow run 41 has successfully completed executing, red may indicate that the workflow run 41 has failed, orange may indicate that a particular node 60 has failed, and grey may indicate that a particular node 60 has not even been initiated. See FIG. 7 for an example in which successful runs 614(S) are indicated by a solid box and a checkmark, an unsuccessful run 614(F) (e.g., on inner ring 310(I)) is indicated by a dashed box and an X mark, and non-initiated runs 614(N) (e.g., on outer rings 310(II), 310(III)) are indicated by a dotted box and a minus mark. In addition, edges 630 emanating from the origin node 602 of a failed workflow run 41 are indicated by dashed-dotted lines, edges 631 emanating from a failed run 614(F) are indicated by dashed lines, edges 633 emanating from a successful run 614(S) are indicated by solid lines, and edges 635 emanating from a non-initiated run 614(N) are indicated by dotted lines.

Returning to FIG. 2, in step 150, workflow GUI 46 draws additional rings 310(II), 310(III), etc. around the innermost ring 310(I).

In step 160, workflow GUI 46 adds, to each additional ring 310(II), 310(III), etc., nodes 314, 316 representing task runs 42 or subflow runs 41 that were invoked by one or more tasks depicted on the next inward ring (and possibly also by one or more tasks depicted on further inward ring(s)), together with edges 320 drawn from the invoking node(s) 314, 316 to the respective added nodes 314, 316 of the additional ring 310. For example, in the context of FIG. 4, ring 310(II) is filled by first adding node 314-II(a) with an edge 320-II(a) from node 314-I(a) and then adding node 314-II(b) with an edge 320-II(b) from node 314-I(c).

In some embodiments, step 160 may include sub-step 162. In sub-step 162, when placing a node 314-II(X) on an upper level ring (e.g., ring 310(II)), workflow GUI 46 determines an ideal position for that node 314-II(X) on that upper ring 310(II) by averaging positions of the nodes 60 in lower rings 58 (e.g., ring 310(I)) whose tasks invoke the task of that node 314-II(X) and placing that node 314-II(X) as close as possible to the ideal position on the ring 310(II), without moving any previously-placed nodes 60. In some embodiments, the averaging is done using angles, while in other embodiments, the averaging is done using position numbers, since there are a fixed number of pre-set positions along each ring 58.

For example, in the context of FIG. 4, since node 314-II(a) is invoked only by node 314-I(a), node 314-II(a) is placed immediately to the right of node 314-I(a). Since node 314-II(b) is invoked only by node 314-I(c), node 314-II(b) should be placed close to node 314-I(c). However, since the maximum numbers of nodes 60 on rings 310(I), 310(II) are different from each other, node 314-II(b) may not be immediately radially outward from node 314-I(c), so edge 320-II(b) is not straight, having a portion that follows the arc between rings 310(I), 310(II).

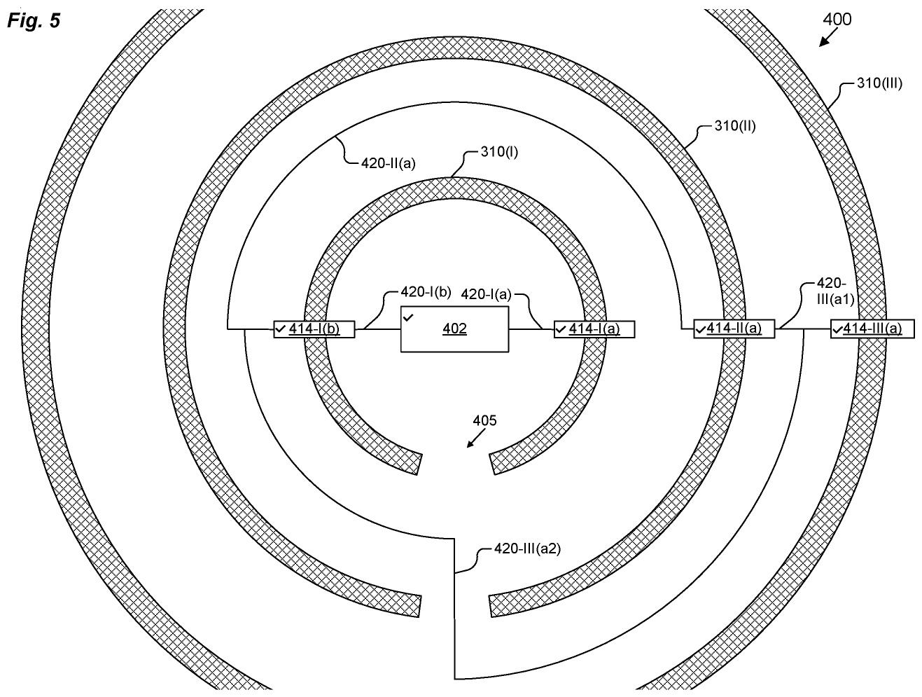

In some embodiments, when the node 60(A) whose task invokes the task of another node 60(B) is located within the top-left quadrant (i.e., 9:00-12:00), then sub-step 162 may be bypassed. Instead, in such a situation, the new node 60(B) is placed in the next available location in the lower-right quadrant. For example, in the context of the visualization 400 of FIG. 5, representing an example of workflow GUI display 56, since node 414-II(a) is invoked by node 414-I(b), and since node 414-I(b) is in the top-left quadrant, node 414-II(a) is placed within the lower-right quadrant. Edge 420-II(a) is drawn following a large (in this case 180-degree) arc in a clockwise direction from node 414-I(b).

In some embodiments, step 160 may include sub-step 164. In sub-step 164, when a node 60(A) depends from at least two nodes 60(B), 60(C) and at least one of the invoking nodes 60(B), 60(C) is not in the immediately adjacent ring 58, then the edge 62 from the non-adjacent ring 58 is drawn to go through a predefined hole 405 within the rings 58 (see FIG. 5). For example, as depicted in FIG. 4, hole 405 is located at the bottom of the visualization 400. Since node 414-III(A) on ring 310(III) is invoked by both node 414-II(a) on the immediately adjacent ring 310(II) and node 414-I(b) on non-adjacent ring 310(I), the edge 420-III(a2) from node 414-I(b) is drawn going through hole 405. Meanwhile, edge 420-III(a1) from node 414-II(a) is drawn straight from the immediately adjacent ring 310(II) without going through hole 405.

In some embodiments, in step 170, when user 50 hovers a cursor (not depicted), using input device 52, directly over a node 60 or an edge 62, the entire path from the origin node 302, 402, 502 to that node 60 or edge 62 is highlighted or otherwise emphasized (e.g., by brightening or thickening the edges 62). For example, in the context of FIG. 5, if the user 50 hovers the cursor over node 414-III(a), then nodes 402, 414-I(b), 414-II(a), and 414-III(a) and edges 420-I(b), 420-II(a), 420-III(a1), and 420-III(a2) would be highlighted.

In some embodiments, in step 180, when user 50 clicks, using input device 52, on an overflow node 515 of a ring 310 (see FIG. 6A), a current visualization 500 transitions to an alternate visualization 500′ (see FIG. 6B) of workflow GUI display 56, in which a larger overflow ring 510 is depicted with all nodes 514′ for that ring 310, 510 shown, bypassing the maximum number. Step 180 also bypasses the rule against moving a previously-drawn node 60, since the nodes 514′ are placed on a new ring 510.

FIG. 8A depicts an example method 700. Method 700 includes various steps that may be performed while placing nodes 60 within innermost ring 310(I). In step 710, workflow GUI 46 selects a first non-dependent run 41, 42 that has not yet been rendered. A non-dependent run is a run 41, 42 that is not dependent on any other run 41, 42 to begin execution.

Then, in step 720, run 41, 42 workflow GUI 46 places the selected run 41, 42 within the first (innermost) ring 310(I) if it is possible to do so. This may be accomplished via sub-steps 725-754. In sub-step 725, workflow GUI 46 determined whether or not the innermost ring 310(I) is full yet. The innermost ring 310(I) is full if the maximum number of nodes 60 for that ring 310(I) (e.g., 16 nodes 60) have already been rendered. If so, in sub-step 727, workflow GUI 46 adds the selected run 41, 42 to the overflow node 515 (and creates the overflow node 515 if it has not yet been rendered).

Otherwise (i.e., if not full), in sub-step 730, workflow GUI 46 determines whether quadrants 2 and 4 are full yet. Quadrant 1 is the upper-right quadrant (corresponding to 12:00 to 3:00). Quadrant 2 is the lower-right quadrant (corresponding to 3:00 to 6:00). Quadrant 3 is the lower-left quadrant (corresponding to 6:00 to 9:00). Quadrant 4 is the upper-left quadrant (corresponding to 9:00 to 12:00). Each quadrant has a maximum number of nodes 60 that it can hold, typically one quarter of the maximum number of nodes 60 for the entire ring 58. If quadrants 2 and 4 are not yet full, then, in sub-step 740, workflow GUI 46 determines whether there are an equal number of nodes 60 already rendered within each of quadrants 2 and 4. If there are, then in sub-step 742, workflow GUI 46 renders the node 60 in the next available position clockwise within quadrant 2 to represent the selected run 41, 42. Otherwise, in sub-step 744, workflow GUI 46 renders the node 60 in the next available position clockwise within quadrant 4 to represent the selected run 41, 42. Thus, sub-steps 740-744 together operate to fill quadrants 2 and 4 at approximately the same rate, ensuring that both quadrants 2 and 4 either have the same number of rendered nodes 60 or that quadrant 2 has exactly one more rendered node 60 than does quadrant 4. It should be understood that, in another embodiment, sub-steps 742, 744 could be swapped.

Returning back to sub-step 730, if quadrants 2 and 4 are already full, then, in sub-step 750, workflow GUI 46 determines whether there are an equal number of nodes 60 already rendered within each of quadrants 1 and 3. If there are, then in sub-step 752, workflow GUI 46 renders the node 60 in the next available position clockwise within quadrant 1 to represent the selected run 41, 42. Otherwise, in sub-step 754, workflow GUI 46 renders the node 60 in the next available position clockwise within quadrant 3 to represent the selected run 41, 42. Thus, sub-steps 750-754 together operate to fill quadrants 1 and 3 at approximately the same rate, ensuring that both quadrants 1 and 3 either have the same number of rendered nodes 60 or that quadrant 1 has exactly one more rendered node 60 than does quadrant 3. It should be understood that, in another embodiment, sub-steps 752, 754 could be swapped.

Thus, sub-steps 730-754 together operate to first fill quadrants 2 and 4 at approximately the same rate, and then to fill quadrants 1 and 3 at approximately the same rate once quadrants 2 and 4 are both full. It should be understood that, in another embodiment, sub-steps 740 (together with sub-steps 752-754), 750 (together with sub-steps 742-744) could be swapped.

After step 720 has completed, workflow GUI 46 renders a straight edge 62 between the just rendered node 60 in the innermost ring 310(I) and the origin node 302, 402, 502, 602. Thus, in the example of FIG. 4, workflow GUI 46 renders edges 320-I(a)-320-I(h). In some embodiments, step 760 includes sub-step 765 in which workflow GUI 46 colors or shades each edge 62 rendered in step 760 according to the success status of the origin node 302, 402, 502, 602. Thus, in the example of FIG. 7, edges 630 are all shown with a dashed-dotted shading pattern because the workflow run 41 depicted in visualization 600, representing an example of workflow GUI display 56, has failed (due to the failure of run 614(F)). In an example in which the main workflow run 41 is still running, a different pattern or color (e.g., a dotted or blue line) may be used instead; and in an example in which the main workflow run 41 has completed successfully, yet a different pattern or color (e.g., a solid or green line) may be used.

In step 770, workflow GUI 46 selects a next non-dependent run 41, 42 that has not yet been rendered, and operation returns back to step 720 to render that node 60.

FIG. 8B depicts an example method 800. Method 800 includes various steps that may be performed while placing nodes 60 within outer rings 310(II), 310(III), etc. In step 810, workflow GUI 46 selects a first dependent run 41, 42 of order N that has not yet been rendered. A dependent run is a run 41, 42 that is dependent on another run 41, 42 to begin execution. A dependent run has order 1 if its execution depends on completion of one or more other runs 41, 42, each of which is itself a non-dependent run (e.g., rendered in method 700). For N>1, a dependent run has order N if any dependent run that its execution is dependent on has an order of at least N−1. With reference to the example of FIG. 5, the run of node 414-II(a) has order 1 because its execution is dependent on completion of the run of node 414-I(b). The run of node 414-III(a) has order 2 because its execution is dependent on completion of the run of node 414-II(a), which itself has order 1. Even though the run of node 414-III(a) is also depicted as being dependent on completion of the run of node 414-I(b), which is a non-dependent node, the run of node 414-III(a) does not have order 1 because of its dependency on node 414-II(a).

In general, dependent nodes of order N are rendered on ring 310(N+1) (unless they are counted within an overflow node 515). Thus, in some embodiments, after execution of method 700, method 800 may be run separately for each value of N beginning with N=1 up to one less than the highest ring number being displayed.

In step 820, workflow GUI 46 places the selected run 41, 42 in the next available node 60 within ring 310(N+1), if it is possible to do so. This may be accomplished via sub-steps 825-832. In sub-step 825, workflow GUI 46 determined whether or not ring 310(N+1) is full yet. The ring 310(N+1) is full if the maximum number of nodes 60 for that ring 310(N+1) (e.g., 24 nodes 60 for second ring 310(II) and 40 nodes 60 for third ring 310(III)) have already been rendered. If so, in sub-step 827, workflow GUI 46 adds the selected run 41, 42 to the overflow node 515 (and creates the overflow node 515 if it has not yet been rendered).

Otherwise (i.e., if not full), in sub-step 830, workflow GUI 46 averages a radial position (e.g., a positive angle measured clockwise from the 12:00 position up to the 6:00 position, and a negative angle measured counterclockwise from the 12:00 position up to the 6:01 position) of all parent nodes 60 of the selected node 60 which happen to be in the immediately lower ring (ring 310(N)). A parent node is a node 60 upon whose run the selected run is dependent. Only parent nodes which happen to be in 310(N+) are considered in sub-step 830. Thus, for example, consider a dependent run of order 1 which is dependent on two non-dependent nodes that have been rendered at 90 degrees and −45 degrees on ring 1. In that example, the result of sub-step 830 would be 22.5 degrees.

Then, in sub-step 832, workflow GUI 46 renders the node for the selected run 41, 42 at the closest unused node position on 310(N+1), with a preference for positions that are clockwise rather than counterclockwise if neither is closer. For example, in the previous example, the radial position calculated in sub-step 830 was 22.5 degrees, but since ring 2 has 24 valid ring positions, each ring position on ring 2 must be a multiple of 15 degrees. Since 22.5 degrees is equidistant from node positions at 15 and 30 degrees, the node position at 30 degrees would be used, since that is clockwise from 22.5 degrees. If the node position at 30 degrees were already in use by another node 60, then the node position at 30 degrees would be used (if available), since that is closer to 22.5 degrees than the next clockwise position of 45 degrees.

After step 820 has completed, in step 840, workflow GUI 46 renders an edge 62 between the just rendered node 60 in ring 310(N+1) and each parent node (at least one of which is located on ring 310(N)). For each edge 62, step 840 may include sub-steps 842, 844, 846, and/or 848. In sub-step 842, workflow GUI 46 determines whether the parent node for the edge 62 in question is in the adjacent ring (i.e., ring 310(N)). If so, then, in sub-step 844, workflow GUI 46 renders the edge 62 completely between rings 310(N) and 310(N+1) without passing over/across the hole 405. If two nodes 60 on adjacent rings 310(N), 310(N+1) have the same radial position (or, in some embodiments, if their radial position is within 5 degrees), then the edge 62 is rendered as a straight line (e.g., edges 320-II(a) and 320-III(a) in FIG. 4 and edge 420-III(a1) in FIG. 5). If two nodes 60 on adjacent rings 310(N), 310(N+1) do not have the same radial position (or, in some embodiments, if their radial position is separated by more than 5 degrees), then the edge 62 is rendered using a stepped (or “elbowed”) connection with two straight lines and an arc centered on the origin node 302, 402, 502, 602, as depicted in FIG. 4 in the example of edge 320-II(b) between nodes 314-I(c), 314-II(b) and in FIG. 7 in the example of edge 635 between rings 310(II), 310(III).

If sub-step 842 has a negative result, then, in sub-step 846, workflow GUI 46 renders the edge 62 to pass through the hole 405. This edge 62 may be rendered using a stepped connection with a first line emanating from the parent node, switching to a first arc centered on the origin node 302, 402, 502, 602 from near the parent node to the hole 405 (going clockwise if the parent node is in quadrants 1 or 2 and going counterclockwise if the parent node is in quadrants 3 or 4), switching to a second line to go through the hole 405 to reach the gap between rings 310(N), 310(N+1), switching to a second arc centered on the origin node 302, 402, 502, 602 from the hole 405 to near the newly-rendered node 62 (going clockwise if the newly-rendered node 62 is in quadrants 3 or 4 and going counterclockwise if the newly-rendered node 62 is in quadrants 1 or 2), and switching to a third line to reach the newly-rendered node 62. For example, referring to FIG. 5, edge 420-III(a2) proceeds from node 414-I(b) on ring 310(I) through hole 405 all the way to node 414-III(a) on ring 310(III).

In some embodiments, step 840 includes sub-step 848 in which workflow GUI 46 colors or shades each edge 62 rendered in step 820 according to the success status of the parent node from which it originates. Thus, in the example of FIG. 7, edge 633 originating from a successful node 614(S) is shown with a solid pattern, edge 631 originating from a failed node 614(F) is shown with a dashed pattern, and edge 635 originating from a non-initiated node 614(N) is shown with a dotted pattern.

In step 850, workflow GUI 46 selects a next dependent run 41, 42 of order N that has not yet been rendered, and operation returns back to step 820 to render that node 60.

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional.” Applicant makes no admission that such technique, method, apparatus, or other concept is actually prior art under 35 U.S.C. § 102 or 103, such determination being a legal determination that depends upon many factors, not all of which are known to Applicant at this time.

What is claimed is:

1. A method, performed by a computing device, of visualizing a run of a workflow on a graphical user interface (GUI) on a display device, the method comprising:
rendering an origin node of the workflow at a central position of the GUI and an innermost ring around the central position;
adding to the first ring of the GUI, independent nodes representing respective tasks invoked by the workflow that are not dependent on any other task, the independent nodes being added in order of invocation in a distributed manner, together with edges drawn from the origin node to respective added independent nodes of the first ring;
rendering one or more outer rings around the innermost ring of the GUI; and
adding to each of the one or more outer rings of the GUI, dependent nodes representing respective tasks invoked by the workflow that are dependent on another task represented by another node on another ring closer to the origin node, the dependent nodes being added in the order of invocation in a distributed manner, together with edges drawn to each added dependent node of the one or more outer rings from all nodes representing tasks upon which the respective task represented by that dependent node is dependent.

2. The method of claim 1 wherein adding independent nodes, dependent nodes, and edges includes:
rendering the independent nodes with coloration or shading representing a completion status of the workflow;
rendering each dependent node with coloration or shading representing a completion status of one or more tasks upon which that dependent node is dependent; and
rendering each edge with coloration or shading representing a completion status of the respective task represented by the node from which that edge was drawn.

3. The method of claim 2 wherein:
the method is performed in real-time as the workflow run is being executed, each node being added as it is invoked; and
the completion status of each independent node, dependent node, and edge is drawn from a set including completed successfully, pending, and failed.

4. The method of claim 2 wherein:
the method is performed after the workflow run has finished execution; and
the completion status of each independent node, dependent node, and edge is drawn from a set including completed successfully, pending, not invoked, and failed.

5. The method of claim 1 wherein adding independent nodes and dependent nodes includes maintaining a position of previously-added nodes.

6. The method of claim 5 wherein:
each of the innermost ring and the one or more outer rings has a respective maximum number of allowed positions at which nodes may be added; and
adding independent nodes and dependent nodes includes, in response to the maximum number of allowed positions for a ring being exceeded, adding additional tasks for that ring to all be represented by a single overflow node depicted on that ring.

7. The method of claim 6 wherein the method further comprises, in response to a user clicking on the overflow node for a ring, re-rendering that ring to depict nodes representing all tasks that were represented by the overflow node for that ring as well as representing all tasks that were represented by other nodes of that ring prior to the user clicking on the overflow node.

8. The method of claim 1 wherein adding the independent nodes to the innermost ring in the distributed manner includes:
initially distributing the independent nodes between a first pair of quadrants of the innermost ring in an equitable manner; and
once the first pair of quadrants have been filled, distributing the independent nodes between a second pair of quadrants of the innermost ring in an equitable manner.

9. The method of claim 1 wherein adding the dependent nodes to the one or more outer rings in the distributed manner includes, for each dependent node in a particular ring:
determining an average radial position of all nodes representing tasks upon which the respective task represented by that dependent node is dependent that are in a ring immediately adjacent to the particular ring; and
placing that dependent node at a closest available position on the particular ring, subject to a direction preference.

10. The method of claim 1 wherein adding edges drawn to each added dependent node of the one or more outer rings includes:
for each edge to each added dependent node on an outer ring from a respective node on the immediately adjacent ring closer to the origin node, rendering that edge completely between the outer ring and the immediately adjacent ring without passing across a hole in the immediately adjacent ring; and
for each edge to each added dependent node on an outer ring from a respective node on a non-adjacent ring closer to the origin node, rendering that edge through the hole in the immediately adjacent ring.

11. The method of claim 1 wherein the method further comprises, in response to a user hovering a cursor over an added independent node, dependent node, or edge, highlighting a path from the origin node to the added independent node, dependent node, or edge over which the cursor was hovering.

12. A computer program product comprising at least one non-transitory computer-readable storage medium storing instructions, which, when performed by processing circuitry of a computing device, cause the computing device to visualize a run of a workflow on a graphical user interface (GUI) on a display device by:
rendering an origin node of the workflow at a central position of the GUI and an innermost ring around the central position;
adding to the first ring of the GUI, independent nodes representing respective tasks invoked by the workflow that are not dependent on any other task, the independent nodes being added in order of invocation in a distributed manner, together with edges drawn from the origin node to respective added independent nodes of the first ring;
rendering one or more outer rings around the innermost ring of the GUI; and
adding to each of the one or more outer rings of the GUI, dependent nodes representing respective tasks invoked by the workflow that are dependent on another task represented by another node on another ring closer to the origin node, the dependent nodes being added in order of invocation in a distributed manner, together with edges drawn to each added dependent node of the one or more outer rings from all nodes representing tasks upon which the respective task represented by that dependent node is dependent.

13. The computer program product of claim 12 wherein adding independent nodes, dependent nodes, and edges includes:
rendering the independent nodes with coloration or shading representing a completion status of the workflow;
rendering each dependent node with coloration or shading representing a completion status of one or more tasks upon which that dependent node is dependent; and
rendering each edge with coloration or shading representing a completion status of the respective task represented by the node from which that edge was drawn.

14. The computer program product of claim 1 wherein adding independent nodes and dependent nodes includes maintaining a position of previously-added nodes.

15. The computer program product of claim 14 wherein:
each of the innermost ring and the one or more outer rings has a respective maximum number of allowed positions at which nodes may be added; and
adding independent nodes and dependent nodes includes, in response to the maximum number of allowed positions for a ring being exceeded, adding additional tasks for that ring to all be represented by a single overflow node depicted on that ring.

16. The computer program product of claim 15 wherein the instructions, when performed by the processing circuitry of the computing device, further cause the computing device to, in response to a user clicking on the overflow node for a ring, re-rendering that ring to depict nodes representing all tasks that were represented by the overflow node for that ring as well as representing all tasks that were represented by other nodes of that ring prior to the user clicking on the overflow node.

17. The computer program product of claim 12 wherein adding the independent nodes to the innermost ring in the distributed manner includes:
initially distributing the independent nodes between a first pair of quadrants of the innermost ring in an equitable manner; and
once the first pair of quadrants have been filled, distributing the independent nodes between a second pair of quadrants of the innermost ring in an equitable manner.

18. The computer program product of claim 12 wherein adding the dependent nodes to the one or more outer rings in the distributed manner includes, for each dependent node in a particular ring:
determining an average radial position of all nodes representing tasks upon which the respective task represented by that dependent node is dependent that are in a ring immediately adjacent to the particular ring; and
placing that dependent node at a closest available position on the particular ring, subject to a direction preference.

19. The computer program product of claim 12 wherein adding edges drawn to each added dependent node of the one or more outer rings includes:
for each edge to each added dependent node on an outer ring from a respective node on the immediately adjacent ring closer to the origin node, rendering that edge completely between the outer ring and the immediately adjacent ring without passing across a hole in the immediately adjacent ring; and
for each edge to each added dependent node on an outer ring from a respective node on a non-adjacent ring closer to the origin node, rendering that edge through the hole in the immediately adjacent ring.

20. An apparatus comprising processing circuitry coupled to memory configured to visualize a run of a workflow on a graphical user interface (GUI) on a display device by:
rendering an origin node of the workflow at a central position of the GUI and an innermost ring around the central position;
adding to the first ring of the GUI, independent nodes representing respective tasks invoked by the workflow that are not dependent on any other task, the independent nodes being added in order of invocation in a distributed manner, together with edges drawn from the origin node to respective added independent nodes of the first ring;
rendering one or more outer rings around the innermost ring of the GUI; and
adding to each of the one or more outer rings of the GUI, dependent nodes representing respective tasks invoked by the workflow that are dependent on another task represented by another node on another ring closer to the origin node, the dependent nodes being added in order of invocation in a distributed manner, together with edges drawn to each added dependent node of the one or more outer rings from all nodes representing tasks upon which the respective task represented by that dependent node is dependent.
